(19) United States
(12) Patent Application Publication
(10) Pub. No.: US 2023/0126957 A1
(43) Pub. Date: Apr. 27, 2023

(54) SYSTEMS AND METHODS FOR DETERMINING FAULT FOR A VEHICLE ACCIDENT

(71) Applicant: PING AN TECHNOLOGY (SHENZHEN) CO., LTD., Shenzhen (CN)

(72) Inventors: QI CHEN, Bethesda, MD (US); Ruei-Sung LIN, Bethesda, MD (US); AI LI, Bethesda, MD (US); ZIJIA CHEN, Bethesda, MD (US)

(73) Assignee: PING AN TECHNOLOGY (SHENZHEN) CO., LTD., Shenzhen (CN)

(21) Appl. No.: 17/511,500

(22) Filed: Oct. 26, 2021

(51) Int. Cl. B60W 30/095; B60W 30/12; G06K 9/00

(52) U.S. Cl. CPC B60W 30/095; B60W 30/12; G06K 9/00798; B60W 2420/42; B60W 2552/53

(57) ABSTRACT

Embodiments of the disclosure provide systems and methods for determining fault for a vehicle accident. An exemplary system includes a communication interface configured to receive a video signal from a camera. The video signal includes a sequence of image frames. The system further includes at least one processor coupled to the communication interface. The at least one processor detects one or more vehicles and one or more road identifiers in the image frames, transforms a perspective of each image frame from a camera view to a top view, determines a trajectory of each detected vehicle in the transformed image frames, identifies an accident based on the determined trajectory of each vehicle, and determines a type of the accident and a fault of each vehicle involved in the accident.

### TECHNICAL FIELD

The present disclosure relates to systems and methods for determining fault for a vehicle accident, and more particularly to determining a type of the accident and a fault of each vehicle involved in the accident.

### BACKGROUND

In recent years, the increasing number of vehicles has not only caused serious traffic congestion, but also increased the occurrence of traffic accidents. Since traffic accidents often leave cars stranded on the roads waiting for staff of insurance companies to inspect and determine fault, which would further exacerbate the traffic congestion, it is desirable to develop a new and innovative way to quickly determine fault for a traffic accident and clear the blocked roads.

Existing methods for determining fault for a traffic accident have the following shortcomings. First, the determination requires human participation. For example, an insurance adjuster may have to be present to visually inspect the scene of accident and speak to the drivers of the vehicles involved before making a judgment as to who acted negligently or is otherwise in violation of traffic rules. The fault determination process therefore becomes time-consuming and can only be processed in a certain time window (e.g., in business hours). Sometimes, a minor collision may take a long time to determine fault, thus disproportionately increasing the time and handling costs for such accidents despite its moderate consequence. Second, in some other existing examples, the faulty party in a traffic accident is determined based on one or more images taken after the accident. In certain cases, these non-real-time images cannot effectively provide firsthand information that would tell others who was at fault. Third, in some systems where a traffic video stream is used as evidence for fault determination, one needs to know an occurrence time of the accident. For example, the insurance adjuster may have to personally review the traffic video to identify when the accident happened and determine the fault based on the video captured around that time. As a result, the fault determination process is very time-consuming and laborious.

To solve the above problems, embodiments of the present disclosure provide systems and methods for automatically detecting a vehicle accident and determining a type of the accident (e.g., rear-end collision, lane-departure collision, or the like) and a fault of each vehicle involved in the accident based on, for example, a traffic video.

### SUMMARY

Embodiments of the disclosure provide a system for determining fault for a vehicle accident. An exemplary system includes a communication interface configured to receive a video signal from a camera. The video signal includes a sequence of image frames with one or more vehicles and one or more road identifiers. The exemplary system further includes at least one processor coupled to the communication interface. The at least one processor detects the one or more vehicles and the one or more road identifiers in the image frames. The at least one processor further transforms a perspective of each image frame from a camera view to a top view. The at least one processor also determines a trajectory of each detected vehicle in the transformed image frames. The at least one processor additionally identifies an accident based on the determined trajectory of each vehicle. The at least one processor further determines a type of the accident and a fault of each vehicle involved in the accident.

Embodiments of the disclosure also provide a method for determining fault for a vehicle accident. An exemplary method includes receiving a video signal, by a communication interface, from a camera. The video signal includes a sequence of image frames with one or more vehicles and one or more road identifiers. The method further includes detecting, by at least one processor coupled to the communication interface, the one or more vehicles and the one or more road identifiers in the image frames. The method also includes transforming, by the at least one processor coupled to the communication interface, based on the detected one or more road identifiers, a perspective of each image frame from a camera view to a top view. The method additionally includes determining, by the at least one processor coupled to the communication interface, a trajectory of each detected vehicle in the transformed image frames. The method further includes identifying, by the at least one processor coupled to the communication interface, an accident based on the determined trajectory of each vehicle. The method also includes determining, by the at least one processor coupled to the communication interface, a type of the accident and a fault of each vehicle involved in the accident.

Embodiments of the disclosure further provide a non-transitory computer-readable medium having instructions stored thereon that, when executed by at least one processor, causes the at least one processor to perform a method for determining fault for a vehicle accident. The method includes receiving a video signal from a camera. The video signal includes a sequence of image frames with one or more vehicles and one or more road identifiers. The method further includes detecting the one or more vehicles and the one or more road identifiers in the image frames. The method also includes transforming based on the detected one or more road identifiers, a perspective of each image frame from a camera view to a top view. The method additionally includes determining a trajectory of each detected vehicle in the transformed image frames. The method further includes identifying an accident based on the determined trajectory of each vehicle. The method also includes determining a type of the accident and a fault of each vehicle involved in the accident.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary fault determination system, according to embodiments of the disclosure.

FIG. 2 illustrates a block diagram of an exemplary fault determination device illustrated in FIG. 1, according to embodiments of the disclosure.

FIG. 3 illustrates a data flow diagram of an exemplary fault determination device illustrated in FIG. 1, according to embodiments of the disclosure.

FIG. 4 illustrates a schematic diagram of an exemplary detection for vehicles and road identifiers in an image frame of a video signal, according to embodiments of the disclosure.

FIG. 5A illustrates a schematic diagram of an exemplary image frame from a camera view, according to embodiments of the disclosure.

FIG. 5B illustrates a schematic diagram of a transformed image frame of FIG. 5A, according to embodiments of the disclosure.

FIG. 6 is a flowchart of an exemplary method for determining a vehicle trajectory, according to embodiments of the disclosure.

FIG. 7 illustrates a schematic diagram of exemplary vehicle trajectories, according to embodiments of the disclosure.

FIG. 8 is a flowchart of an exemplary method for determining a type of an accident and an at-fault party, according to embodiments of the disclosure.

FIG. 9 is a flowchart of an exemplary method for determining fault for a vehicle accident, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The disclosed systems and methods automatically detect a vehicle accident and determine fault for the vehicle accident. In some embodiments, an exemplary fault determination system may receive a video signal captured by a video camera. The video signal may include a sequence of image frames. For example, each image frame may include one or more vehicles and one or more road identifiers. In some embodiments, the vehicles and the road identifiers may be detected using a deep learning model based on the received video signal. For example, a faster Region-based Convolutional Neural Networks (faster R-CNN) model may be used to detect vehicles and road identifiers within each image frame of the video signal. In some embodiments, a perspective of each image frame may be transformed from a camera view to a top view based on one or more detected road identifiers. For example, a Homographic Matrix Transformation method may compute a homography matrix based on two selected road lines in an image frame and transform the perspective of the image frame from the camera view to the top view based on the computed homography matrix.

In some embodiments, motion information may be extracted based on pairs of adjacent image frames using an optical flow method. The trajectory of each vehicle is then determined based on the detected vehicles in image frames. In some embodiments, an accident may be identified based on the determined trajectory of each vehicle. For example, one or more vehicles that exceed a threshold of accident probability may be selected as candidate vehicles for assigning fault based on the trajectory of each vehicle in the video. A spatial relationship between each pair of the candidate vehicles may be evaluated to identify the accident and the involved vehicles. In some embodiments, an occurrence time of the accident may be determined in the video, without the need for visual inspection by humans.

In some embodiments, the fault determination system may determine a type of the accident and a fault of each vehicle involved in the accident. For example, the system may determine the type of the accident based on a relative motion between the two vehicles involved when the accident occurs, and a relative position between and status of the two vehicles after the accident occurs. If the type of the accident is a rear-end collision, the system may determine the fault of each vehicle involved in the accident based on a relative velocity of the two vehicles when the accident occurs and a velocity change of the two vehicles after the accident occurs. If the type of the accident is a lane-departure collision, the system may determine the fault of each vehicle involved in the accident based on a relative motion of the two vehicles when the accident occurs and a relative position of a road identifier to each vehicle, respectively.

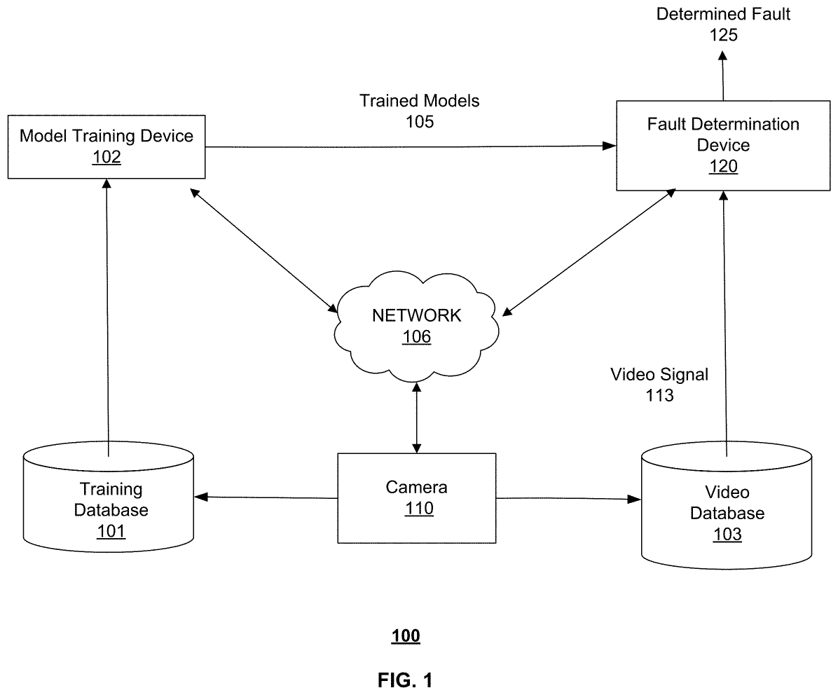

FIG. 1 illustrates an exemplary fault determination system 100 (referred to as “system 100” hereafter), according to embodiments of the disclosure. In some embodiments, system 100 may detect a vehicle accident based on a video signal and determine a type of the accident and a fault of each vehicle involved in the accident. As shown in FIG. 1, system 100 may include components for performing two phases, a training phase and a fault determination phase. To perform the training phase, system 100 may include a training database 101 and a model training device 102. To perform the fault determination phase, system 100 may include a fault determination device 120. In some embodiments, system 100 may include components additional to those shown in FIG. 1. For example, system 100 may include a LiDAR (Light Detection and Ranging) device that detects the distance between the device and the objects captured in the image frames. In other embodiments, some components of system 100 shown in FIG. 1 may be spared. For example, when learning models for determining fault for the vehicle accident are pre-trained and provided, system 100 may not need training database 101 or model training device 102.

In some embodiments, system 100 may optionally include a network 106 to facilitate the communication among the various components of system 100, such as databases 101 and 103, devices 102 and 120, and a camera 110. For example, network 106 may be a local area network (LAN), a wireless network, a cloud computing environment (e.g., software as a service, platform as a service, infrastructure as a service), a client-server, a wide area network (WAN), etc. In some embodiments, network 106 may be replaced by wired data communication systems or devices. Network 106 may provide speed and bandwidth sufficient for transmitting data between the abovementioned components so that the time lag is minimized and real-time processing of the automatic determination of fault is not affected. Camera 110 may be any type of image capturing device capable of observing vehicular traffic on a road and taking images thereof, whether still, motion, or both. Camera 110 may also be equipped with night-vision functionalities, which can be implemented by an infrared sensor, an auxiliary camera with high dynamic range, etc. Camera 110 may optionally operate with a flash that provides a short burst of bright light during the exposure to illuminate the target objects for clearer images.

In some embodiments, the various components of system 100 may be remote from each other or in different locations, and be connected through network 106 as shown in FIG. 1. In some alternative embodiments, certain components of system 100 may be located on the same site or inside one device, resulting in a high level of system integration. For example, training database 101 may be located on-site with or be part of model training device 102. As another example, model training device 102 and fault determination device 120 may be inside the same computer or processing device.

As shown in FIG. 1, model training device 102 may communicate with training database 101 to receive one or more sets of training data. Model training device 102 may use the received data to train a plurality of deep learning models (e.g., trained learning models 105). Trained learning models 105 may include an object detection model, a motion computing model, or both. For example, the object detection model may be trained as a faster R-CNN model using Convolution Neural Networks (e.g., Single Shot Detector (SSD) network) for detecting vehicles and road identifiers. The motion computing model may be trained using an optical flow method to compute the motion of objects (e.g., vehicle, pedestrian, cyclist, or the like) in the video. The motion information of the objects may be expressed as a vector field and used for determining fault.

In some embodiments, the training phase may be performed online or offline. An online training refers to performing the training phase contemporarily with the fault determination phase, e.g., learning the models in real-time just prior to determining fault for the detected vehicle accident. An online training may have the benefit of obtaining most updated deep learning models based on the training data that is then available. However, an online training may be computationally costly to perform and may not always be possible if the training data is large and/or the models are complicated. Consistent with the present disclosure, an offline training may be used where the training phase is performed separately from the fault determination phase. The learned models are trained offline and saved and reused for determining fault for the detected vehicle accident.

Model training device 102 may be implemented with hardware specially programmed by software that performs the training process. For example, model training device 102 may include a processor and a non-transitory computer-readable medium. The processor may conduct the training by performing instructions of a training process stored in the computer-readable medium. Model training device 102 may additionally include input and output interfaces to communicate with training database 101, network 106, and/or a user interface (not shown). The user interface may be used for selecting sets of training data, adjusting one or more parameters of the training process, selecting or modifying a framework of the deep learning models, and/or manually or semi-automatically providing ground-truth associated with the training data.

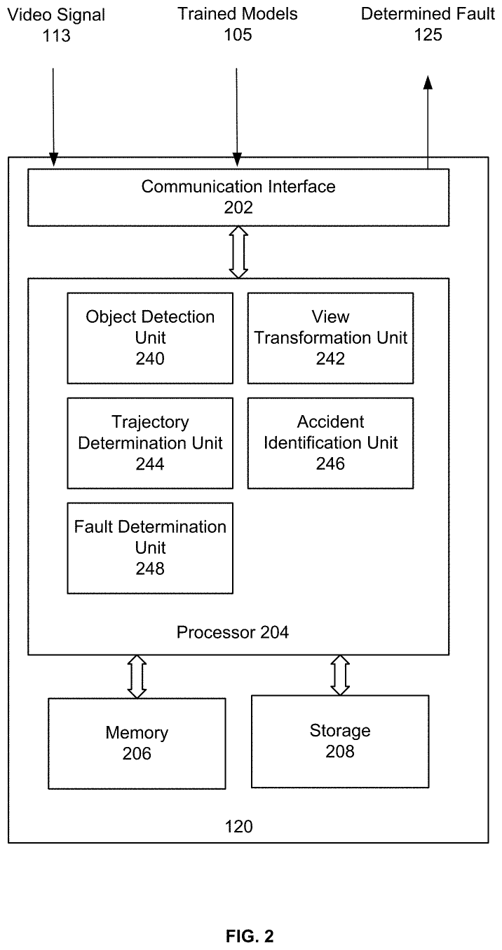

Trained learning models 105 may be used by fault determination device 120 to determine the type of the accident and the fault of each involved accident that is not associated with a ground-truth. Fault determination device 120 may receive trained learning models 105 from model training device 102. Fault determination device 120 may include a processor and a non-transitory computer-readable medium (discussed in detail in connection with FIG. 2). The processor may perform instructions of a sequence of processes stored in the medium for determining fault for the vehicle accident. Fault determination device 120 may additionally include input and output interfaces to communicate with video database 103, network 106, and/or a user interface (not shown). The user interface may be used for receiving one or more video signals for fault determination, initiating the determination process, displaying a determination result (e.g., determined fault 125). For example, determined fault 125 may include a type of the accident, each vehicle involved in the accident, fault attributed to each involved vehicle, and an occurrence time of the accident.

Fault determination device 120 may communicate with video database 103 to receive one or more video signals 113. Consistent with the present disclosure, video signal 113 may include a sequence of image frames with one or more vehicles and one or more road identifiers. Each image frame represents a timing point of video signal 113. At a given timing point, an image frame may include no vehicles. This is possible when the camera is capturing the video at night or during the day (between two rush-hour periods). Collectively, the sequence of image frames includes at least one vehicle and one road identifier in order for it to be analyzed for determining fault for a vehicle accident.

In some embodiments, video signals stored in video database 103 are captured by camera 110 which may be a video camera taking live video of vehicular traffic on a road. In some embodiments, camera 110 may be mounted on high poles or masts, sometimes along with streetlights. In some alternative embodiments, camera 110 may be mounted on traffic light poles at intersections, where accidents are most likely to occur. Fault determination device 120 may use trained learning models 105 received from model training device 102 to perform one or more of the following: (1) detecting one or more vehicles and one or more road identifiers in each frame, (2) transforming a perspective of each image frame from a camera view to a top view based on the detected road identifiers, (3) determining a trajectory of each detected vehicle in the transformed image frames, (4) identifying an accident based on the determined trajectory of each vehicle, and (5) determining a type of the accident and a fault of each vehicle involved in the accident.

FIG. 2 illustrates a block diagram of an exemplary fault determination device 120, according to embodiments of the disclosure. Consistent with the present disclosure, fault determination device 120 may receive video signal 113 from video database 103 and trained learning models 105 from model training device 102. The reception of these two different data streams may be simultaneous or sequential. Fault determination device 120 may determine a type of the accident and a fault attributed to each involved vehicle using trained learning models 105 based on video signal 113. Consistent with the present disclosure, fault determination device 120 may generate determined fault 125 including the type of the accident, the fault of each involved vehicle, and the occurrence time of the accident. The determined fault 125 may be output to the outside of fault determination device 120 for further processing.

In some embodiments, as shown in FIG. 2, fault determination device 120 may include a communication interface 202, a processor 204, a memory 206, and a storage 208. In some embodiments, fault determination device 120 may include different modules in a single device, such as an integrated circuit (IC) chip (implemented as an application-specific integrated circuit (ASIC) or a field-programmable gate array (FPGA)), or separate devices with dedicated functions. In some embodiments, one or more components of fault determination device 120 may be located in a cloud, or alternatively in a single location (such as a mobile device) or distributed locations. Components of fault determination device 120 may be in an integrated device, or distributed at different locations but communicate with each other through a network (not shown).

Communication interface 202 may receive data from components such as video database 103 and model training device 102 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive video signal 113 from video database 103 and trained models from model training device 102. In some alternative embodiments, communication interface 202 may receive video signal 113 from camera 110 directly. Communication interface 202 may further provide the received data to storage 208 for storage or to processor 204 for processing.

Processor 204 may be a processing device that includes one or more general processing devices, such as a microprocessor, a central processing unit (CPU), a graphics processing unit (GPU), and the like. More specifically, processor 204 may be a complex instruction set computing (CISC) microprocessor, a reduced instruction set computing (RISC) microprocessor, a very long instruction word (VLIW) microprocessor, a processor running other instruction sets, or a processor that runs a combination of instruction sets. Processor 204 may also be one or more dedicated processing devices such as application specific integrated circuits (ASICs), field programmable gate arrays (FPGAs), digital signal processors (DSPs), system-on-chip (SoCs), and the like.

Processor 204 may be configured as a separate processor module dedicated to performing processing video signal 113 from video database 103 or camera 110. Alternatively, processor 204 may be configured as a shared processor module for performing other functions. Processor 204 may be communicatively coupled to memory 206 and/or storage 208 and configured to execute the computer-executable instructions stored thereon.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may store one or more computer programs that may be executed by processor 204 to perform fault determination disclosed herein. For example, memory 206 and/or storage 208 may store program(s) that may be executed by processor 204 to determine the type of the accident and the fault of the vehicles involved in the accident.

Memory 206 and/or storage 208 may further store information and data used by processor 204. For instance, memory 206 and/or storage 208 may store various types of data, such as video signals received from video database 103 or camera 110. Memory 206 and/or storage 208 may also store intermediate data, such as the location and characteristics of the detected vehicles and road identifiers, and the determined trajectory of each detected vehicle. Memory 206 and/or storage 208 may further store various deep learning models used by processor 204, such as the object detection model, the motion computing model, and the like. The various types of data may be stored permanently, removed periodically, or disregarded immediately after each frame of data is processed.

As shown in FIG. 2, processor 204 includes multiple modules, such as an object detection unit 240, a view transformation unit 242, a trajectory determination unit 244, an accident identification unit 246, a fault determination unit 248, and the like. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 240, 242, 244, 246 and 248 all within one processor 204, it is contemplated that these units may be distributed among multiple processors located near or remotely with each other. According to the present disclosure, the number and type of these modules are not limited to those shown in FIG. 2.

In some embodiments, units 240, 242, 244, 246 and 248 of FIG. 2 may execute computer instructions to perform accident identification and fault determination. In some embodiments, object detection unit 240 may apply the trained learning model (e.g., fast R-CNN model) on each image frame of the received video signal to detect one or more vehicles and one or more road identifiers. For example, the vehicles may be any kind of on-road motor vehicles such as cars, buses, taxies, trucks, and the like. With the advancement of transportation technology, application of the present disclosure to autonomous driving cars, passenger aircrafts, or any other type of vehicles suitable for commute or transportation may also be conceivable. Road identifiers may include road surface markings (e.g., solid white line, broken white line, single solid yellow line, double solid yellow lines, broken yellow line, arrow marking, and the like), road signs (e.g., stop sign, yield sign, prohibition sign, and the like), separators between lanes of opposite directions, road shoulders, light poles, trees, and any other type of objects on the road that can be used for identification purpose.

In some embodiments, view transformation unit 242 may select two or more detected road identifiers to compute a homography matrix and transform the perspective of the image frame from the camera view to the top view based on the computed homography matrix. In some alternative embodiments, view transformation unit 242 may use the same algorithm to transform the perspective of the image frame between two of the plurality of views selected from the group consisting of at least the camera view, the top view, the front view, the rear view, the left side view, the right side view, the bottom view, the pedestrian view, etc.

In some embodiments, trajectory determination unit 244 may extract motion information in the video signal using an optical flow method. In some alternative embodiments, if the video camera keeps static, frame difference method or background subtraction method may be used to extract motion information in the video signal. Trajectory determination unit 244 may further determine the trajectory of each vehicle based on the detected vehicles in each image frame.

In some embodiments, accident identification unit 246 may determine one or more candidate vehicles that exceed a threshold of accident probability based on the trajectory of each detected vehicle. In the case where two vehicles are involved in one accident, accident identification unit 246 may further evaluate the spatial relationship between the two candidate vehicles to identify the accident. Accident identification unit 246 may also determine the occurrence time of the accident.

In some embodiments, fault determination unit 248 may determine the type of the identified accident (e.g., rear-end collision, lane-departure collision, or other type of collision) and the fault of each vehicle involved in the accident. For example, fault determination unit 248 may determine the type of the accident and the at-fault party based on motion information and spatial relationship of the one or more vehicles involved in the accident.

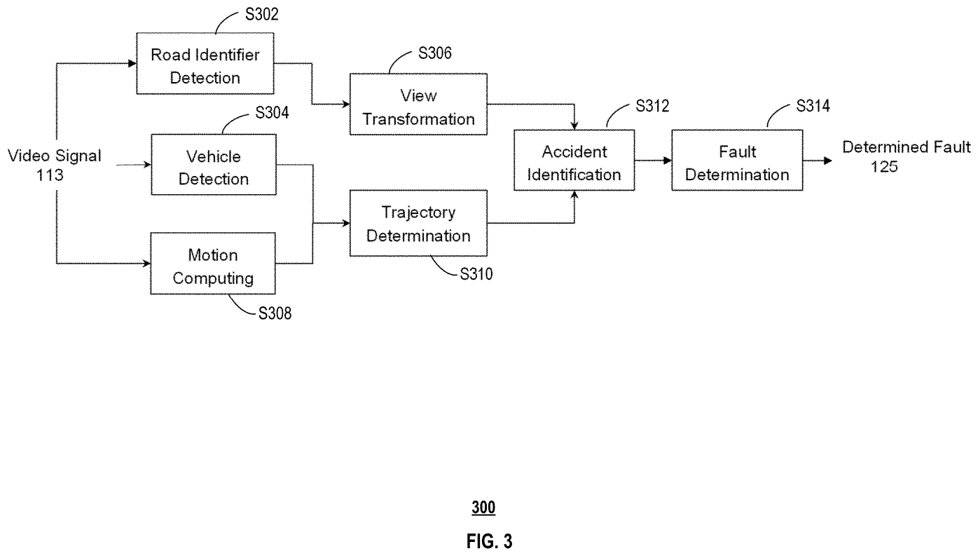

FIG. 3 illustrates a data flow diagram of an exemplary fault determination device 120 illustrated in FIG. 1, according to embodiments of the disclosure. As shown in FIG. 3, fault determination device 120 receives video signal 113 from video database 103 or camera 110 (not shown). Consistent with the present disclosure, video signal 113 may include the sequence of image frames with one or more vehicles and one or more road identifiers.

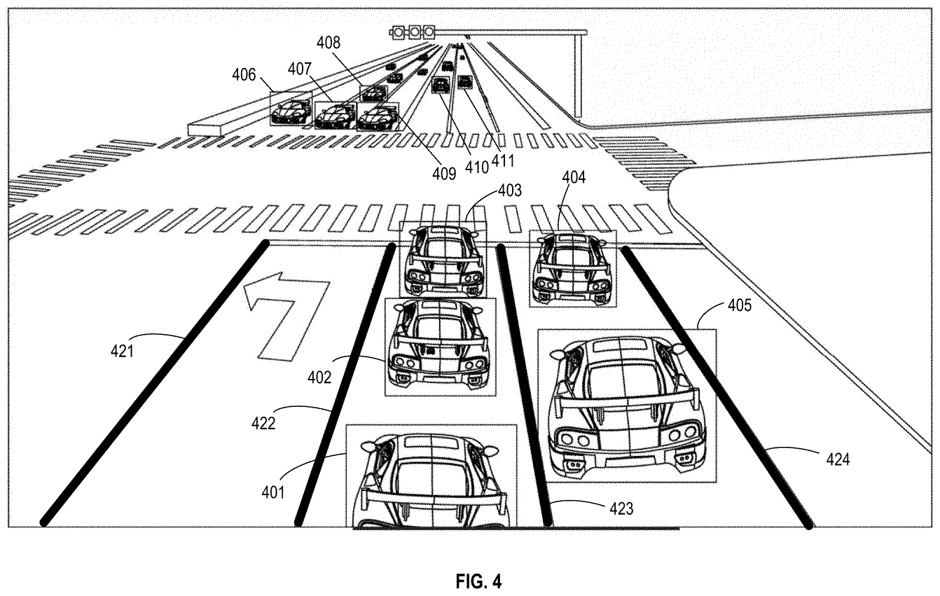

In some embodiments, object detection unit 240 of processor 204 may receive video signal 113 from communication interface 202 and decompose video signal 113 into a series of chronologically ordered image frames. Object detection unit 240 may further adjust resolution and format of the image frames to meet an input requirement for learning models (e.g., faster R-CNN model). In other embodiments, object detection unit 240 may also process raw images captured by camera 110. In step S302 of FIG. 3, object detection unit 240 of processor 204 may detect road identifiers in each image frame using a first faster R-CNN model trained for detecting road identifiers. In step S304, object detection unit 240 of processor 204 may further apply a second faster R-CNN model trained for detecting vehicles in each image frame. In some alternative embodiments, a third faster R-CNN model can be trained by model training device 102 for detecting both vehicle and road identifier simultaneously. For example, object detection unit 240 of processor 204 may apply the third faster R-CNN model on each image frame to detect vehicles and road identifiers simultaneously. FIG. 4 illustrates a schematic diagram of an exemplary detection for vehicles and road identifiers in an image frame of a video signal, according to embodiments of the disclosure. As shown in FIG. 4, detected vehicles are illustrated in bounding boxes 401, 402, 403, 404, 405, 406, 407, 408, 409, 410, and 411. Lines 421, 422, 423, and 424 are representative of detected road identifiers (e.g., road surface lines).

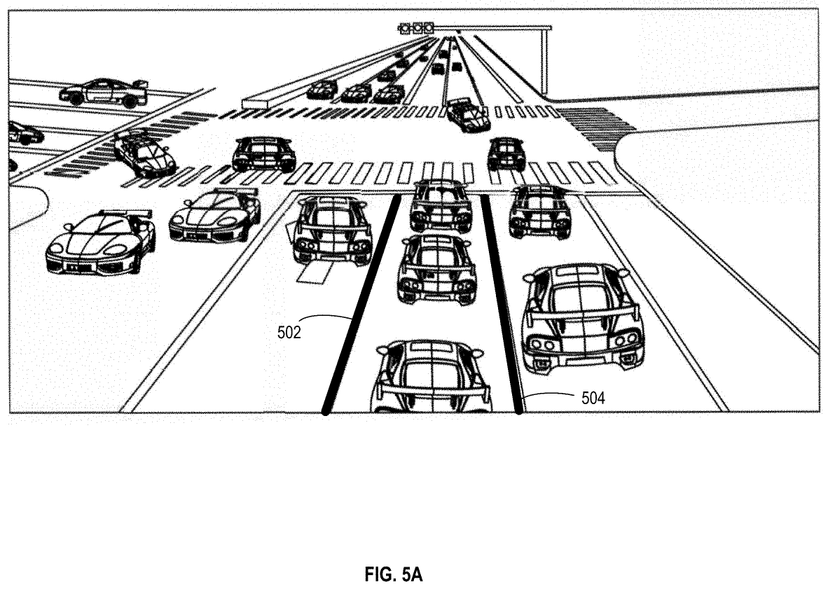

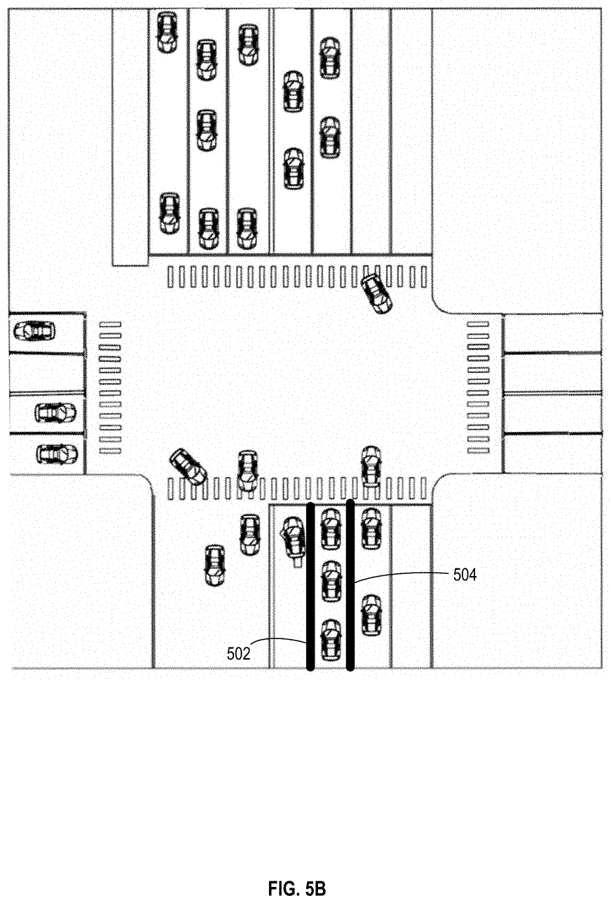

Returning to FIG. 3, in step S306, view transformation unit 242 of processor 204 may transform a perspective of each image frame from a camera view to a top view. FIG. 5A illustrates a schematic diagram of an exemplary image frame from a camera view, according to embodiments of the disclosure. In some embodiments, view transformation unit 242 may select two road identifiers (e.g., road lines) that are parallel to each other in a target perspective of the image frame (e.g., top view) to compute a homography matrix. For example, as shown in FIG. 5A, lines 502 and 504 are two road lines detected by object detection unit 240 and selected by view transformation unit 242 to compute the homography matrix. In some embodiments, the homography matrix H may be determined according to Equation (1):

H=T₂R_{xy}RₓₓR_{yz}T₁⁻¹ (1)

Matrix T₁ in Equation (1) is configured to transform a point from two-dimensional coordinate system to three-dimensional coordinate system. R_{xy} is a 3 by 3 rotation matrix around z-axis, R_{xz} is a 3 by 3 rotation matrix around y-axis, and R_{yz} is a 3 by 3 rotation matrix around x-axis. Matrix T₂ in Equation (1) is configured to transform the point from a three-dimensional coordinate system back to a two-dimensional coordinate system.

In some embodiments, coordinates of each point in a source image coordinate system as shown in FIG. 5A can be transformed to a target image coordinate system as shown in FIG. 5B according to Equation (2):

P₂=αH·P₁ (2)

where H is the homography matrix computed by Equation (1) based on the two selected road identifiers, α is a scale coefficient, P₁ is the coordinates of a point in the source image coordinate system, and P₂ is the transformed coordinates of the point in the target image coordinate system. FIG. 5B illustrates a schematic diagram of a transformed image frame of FIG. 5A, according to embodiments of the disclosure. As shown in FIG. 5B, lines 502 and 504 are parallel to each other in the transformed image frame. The transformed perspective (e.g., top view) shows an actual spatial relationship of the vehicles in the Cartesian coordinate system, which may improve the system performance on accident identification and fault determination.

Returning to FIG. 3, in step S308, trajectory determination unit 244 of processor 204 may extract motion information in the video signal 113 using a motion computing model trained based on an optical flow method. For example, trajectory determination unit 244 may apply the motion computing model on pairs of adjacent image frames to compare pixel intensities between each pair of the adjacent image frames. The motion information is then extracted based on the comparison and expressed as a vector field using the motion computing model. In some embodiments, trajectory determination unit 244 may be a Graphic Processing Unit (GPU) to receive the sequence of image frames and extract motion information using the optical flow method.

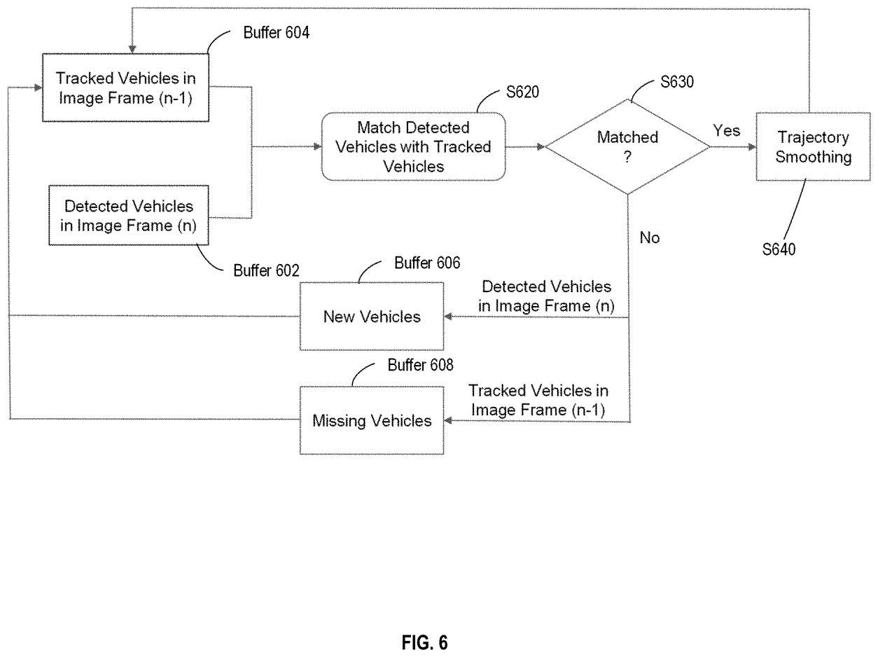

In step S310, trajectory determination unit 244 of processor 204 may further determine the trajectory of each vehicle based on the vehicles detected in step S304. FIG. 6 is a flowchart of an exemplary method for determining a vehicle trajectory, according to embodiments of the disclosure. As shown in FIG. 6, trajectory determination unit 244 may track each detected vehicle and determine the trajectory of each vehicle. For example, video signal 113 may include m image frames, and the detected vehicles in the first image frame of video signal 113 may be used as the initial batch of tracked vehicles and stored in a buffer 604.

As shown in FIG. 6, in step S620, trajectory determination unit 244 may associate each detected vehicle in image frame (n) (1<n<=m) (in a buffer 602) with tracked vehicles in image frame (n−1) (in buffer 604). For example, a similarity matrix may be generated based on information of the detected vehicles in image frames (n−1) and (n). Each value in the similarity matrix is a similarity between each pair of the detected vehicles in image frames (n−1) and (n). The similarity can be either an Intersection over Union (IOU) of two bounding boxes or an appearance similarity of the two vehicles. In some embodiments, Hungarian algorithm or greedy algorithm may be applied on the similarity matrix to associate vehicles between image frames (n−1) and (n).

If a detected vehicle in image frame (n) is successfully associated with a tracked vehicle in image frame (n−1) (step S630: Yes), trajectory determination unit 244 may smooth the trajectory of the vehicle from image frame (n−1) to image frame (n) in step S640. For example, a probabilistic model (e.g., Kalman filter, particle filter, or the like) may be applied to characteristics (e.g., location, size, or the like) of the tracked vehicle in image frame (n−1) as state variables to predict a bounding box of the vehicle in image frame (n). As a result, the trajectory of the vehicle becomes smoother and more natural. Further, according to the above embodiments, small-scale noise does not cause a large fluctuation in the trajectory of the vehicle.

If the detected vehicle in image frame (n) is not associated with any tracked vehicle in image frame (n−1) (step S630: No), the detected vehicle in image frame (n) may be stored as a new vehicle in buffer 606. In some embodiments, if the new vehicle in buffer 606 is successfully tracked in a plurality of subsequent image frames (e.g., two, four, eight, ten, or more subsequent image frames), the new vehicle may be considered as a tracked vehicle and moved to buffer 604.

If the tracked vehicle in image frame (n−1) is not associated with any detected vehicle in image frame (n) (step S630: No), the tracked vehicle in image frame (n−1) may be stored as a missing vehicle in buffer 608. In some embodiments, if the missing vehicle is successfully associated with a detected vehicle in a plurality of subsequent image frames (e.g., two, four, eight, ten, or more subsequent image frames), the missing vehicle may be moved back to buffer 604 and considered as the tracked vehicle. If a missing vehicle is not successfully associated with any detected vehicle within a threshold number of subsequent image frames (e.g., ten image frames), trajectory determination unit 244 may give up tracking of the missing vehicle and remove the missing vehicle from buffer 608. The threshold number may be preset or adjusted according to the need of the user, the computational capacity of the system, or the storage space of the buffers.

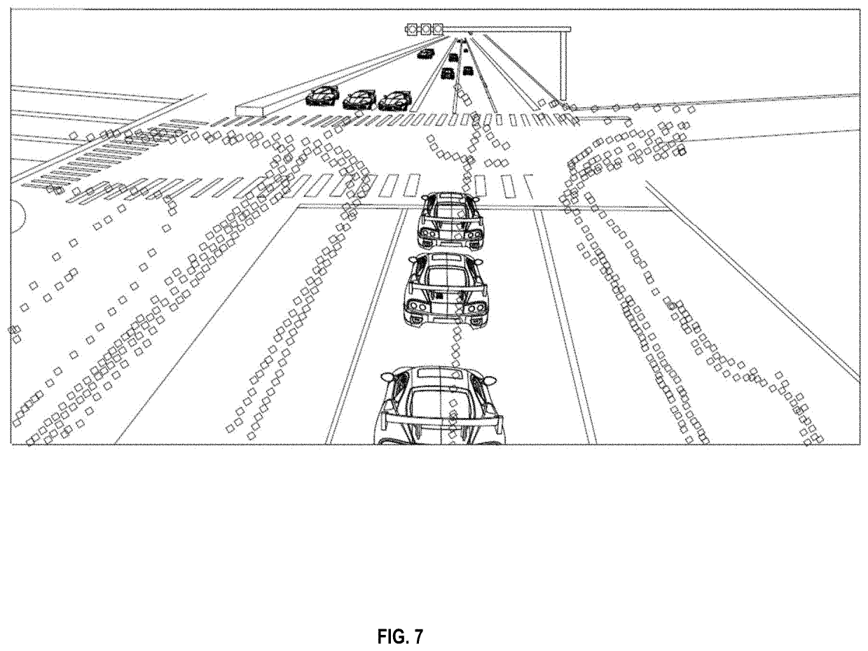

FIG. 7 illustrates a schematic diagram of exemplary vehicle trajectories, according to embodiments of the disclosure. As shown in FIG. 7, the trajectories are illustrated in diamond markers. Each diamond marker includes spatial information and time information of a detected vehicle in the video signal. For example, the spatial information may be determined based on a centroid of a bounding box of the detected vehicle. The time information may be determined based on a timestamp associated with the image frame including the detected vehicle.

Returning to FIG. 3, the trajectories determined in step S310 and the homography matrix computed in step S306 are used by accident identification unit 246 to identify an accident in step S312. In some embodiments, accident identification unit 246 may transform the trajectory of vehicles from the camera view to the top view according to Equation (2). In some embodiments, accident identification unit 246 may further choose one or more vehicles that exceed a predetermined threshold of accident probability (e.g., a predetermined period) based on the determined trajectory of each detected vehicle. For example, if a vehicle stops moving over the predetermined period (e.g., two, four, five, eight, ten or more minutes), the vehicle may be chosen as a candidate vehicle that may be involved in an accident.

In some embodiments, accident identification unit 246 may evaluate a spatial relationship between each pair of the candidate vehicles to determine whether any pair of candidate vehicles have ever come close to each other based on the trajectories of the two vehicles. The spatial relationship of each pair of the candidate vehicles may include at least one of the following: a distance between the candidate vehicle pair, an overlap degree of bounding boxes of the candidate vehicle pair (e.g., IOU), a relative motion of the candidate vehicle pair, a relative position of the candidate vehicle pair after an accident occurs, or a status of the candidate vehicle pair after the accident occurs. The relative motion of the candidate vehicle pair can be a relative movement direction (e.g., towards or away) of the two vehicles based on the motion information extracted in step S308. The relative position of the candidate vehicle pair after an accident occurs can be a distance between the two candidate vehicles after a time point such as an occurrence time of the accident. For example, the distance between the two vehicles may be small after the accident occurs. The status of the candidate vehicle pair after the accident occurs may be a relative movement trend of the two vehicles. For example, the two vehicles may both stop moving for a while after the accident occurs. As another example, one vehicle may stop moving, and another vehicle may keep moving (e.g., hit-and-run). In some embodiments, if the spatial relationship between a pair of the candidate vehicles exceeds a predetermined threshold, an accident can be identified. The pair of the candidate vehicles are therefore determined as the vehicles involved in the accident.

In some embodiments, accident identification unit 246 may further determine an image frame that is closest in time to the occurrence of the accident based on the trajectories of the candidate vehicles. For example, accident identification unit 246 may determine an occurrence time of the accident based on the respective trajectories of two involved vehicles. An image frame in the image frame sequence that first includes a distance between the two trajectories below a predetermined value (e.g., 0.1 m, 0.05 m. 0.01 m, or less) can be selected and a timestamp associated with the selected image frame may be determined as the occurrence time of the accident. The predetermined value may be chosen so that the probability of vehicles in the real world can move freely within that distance is extremely low, which indicates occurrence of an accident.

In step S314, fault determination unit 248 of processor 204 may determine a type of the accident identified in step S312 and a fault attributed to each vehicle involved in the identified accident. The type of the identified accident can be a rear-end collision, a lane-departure collision, a T-bone collision, a small-overlap collision, a collision involving non-vehicle (e.g., pedestrian, cyclist, road median strip, streetlight pole, or the like), etc. In some embodiments, fault determination unit 248 of processor 204 may determine the type of the accident (e.g., rear-end collision, lane-departure collision, or other type of accident) and the fault attributed to each involved vehicle based on their respectively determined trajectories.

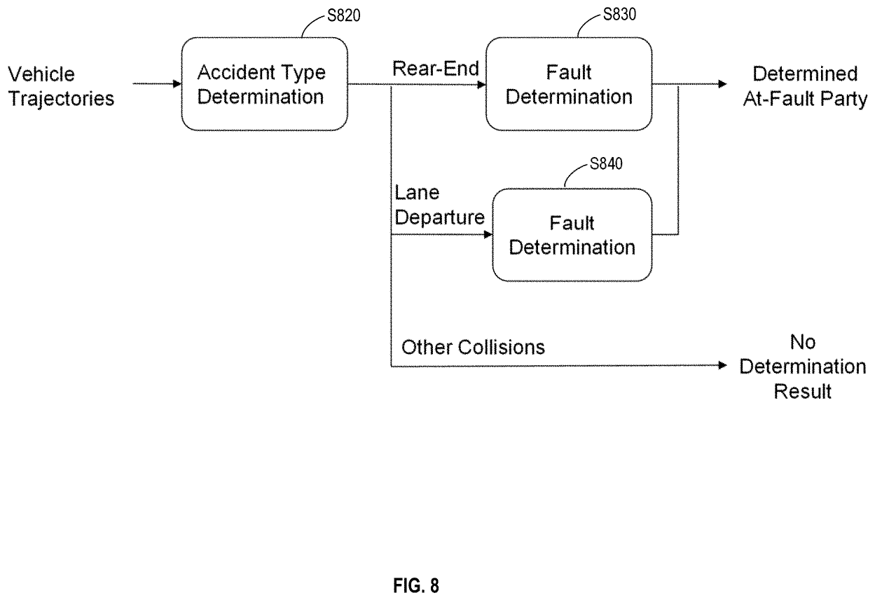

For example, FIG. 8 is a flowchart of an exemplary method for determining a type of an accident and an at-fault party, according to embodiments of the disclosure. In step S314, fault determination unit 248 of processor 204 may determine the type of the accident and the at-fault party or parties for the accident based on the determined trajectories. In step S820 of FIG. 8, an accident type is determined based on a relative motion of the two vehicles when the accident occurs, and a relative position and a status of the two vehicles after the accident occurs. In some embodiments, fault determination unit 248 may determine whether a pair of the vehicles are involved in a rear-end collision. For example, a first vehicle moves forward and bumps the rear of a second vehicle. Both vehicles stop after the collision. In this case, the type of the accident may be determined by fault determination unit as a rear-end collision.

In step S830, fault determination unit 248 may further determine an at-fault party in the rear-end collision. In some embodiments, fault determination unit 248 may determine the at-fault party or parties and attribute fault proportionally to each party involved based on a relative velocity of the two vehicles when the accident occurs and a velocity change of the two vehicles after the accident occurs. In some embodiments, the information of the relative velocity and the velocity change may be obtained based on the motion information computed in step S308 of FIG. 3. For example, if both vehicles move towards the same direction in the same lane and the rear vehicle hits the front vehicle from behind, the rear vehicle's driver may be deemed to be at fault and liable for damages. As another example, a vehicle in the front accelerates in reverse and hits the vehicle behind it, the front vehicle's driver may be deemed to be at fault and liable for damages. Consistent with some embodiments, fault determination unit 248 may generate determined fault 125 including the determined at-fault party or parties, the type of the accident, the occurrence time of the accident, etc.

Returning to step S820 of FIG. 8, if the accident is not a rear-end collision, fault determination unit 248 may further look into whether the accident is a lane-departure collision based on the relative velocity of the two vehicles when the accident occurs and the velocity change of the two vehicles after the accident occurs. For example, if at least one of the two vehicles drifted out of the lane it was traveling when the accident occurred, the accident can be determined as a lane-departure collision. As another example, if a first vehicle that drifted out of the lane stopped across a road line and a second vehicle stayed in the lane after the accident occurred, the accident can be determined as a lane-departure collision.

After determining the accident being a lane-departure collision, fault determination unit 248 may further attribute fault proportionally to one or more parties involved in the lane-departure collision. In step S840, fault determination unit 248 may determine the at-fault party or parties based on a relative motion of the two vehicles when the accident occurs and a relative position of a road identifier to each vehicle, respectively. For example, if a first vehicle drifts out of lane and crashes a second vehicle which drives forwards in lane, the driver of the first vehicle is determined as an at-fault party and responsible for the accident. As another example, if both vehicles drift out of their own lanes and hit each other in another lane, both drivers are at-fault. Consistent with some embodiments, fault determination unit 248 may generate determined fault 125 that includes the determined at-fault party or parties, the type of the accident, the occurrence time of the accident, etc. Returning to step S820, if the accident type is neither a rear-end collision nor a lane-departure collision, fault determination unit 248 may not generate any determination results as shown in FIG. 8 in this example. In other embodiments, fault determination unit 248 may be able to make additional fault determinations based on a type of accident different from read-end and lane-departure collisions. They can be implemented by the same components of the system with different algorithms for such determination.

It is noted that the above are non-limiting examples of how fault is determined by the system according to the present disclosure. In some embodiments, fault determination unit 248 may be installed or loaded with software programs that include computer algorithms as to how to determine and/or attribute fault in a traffic accident, which are compiled according to traffic rules of different jurisdictions and translated into machine language.

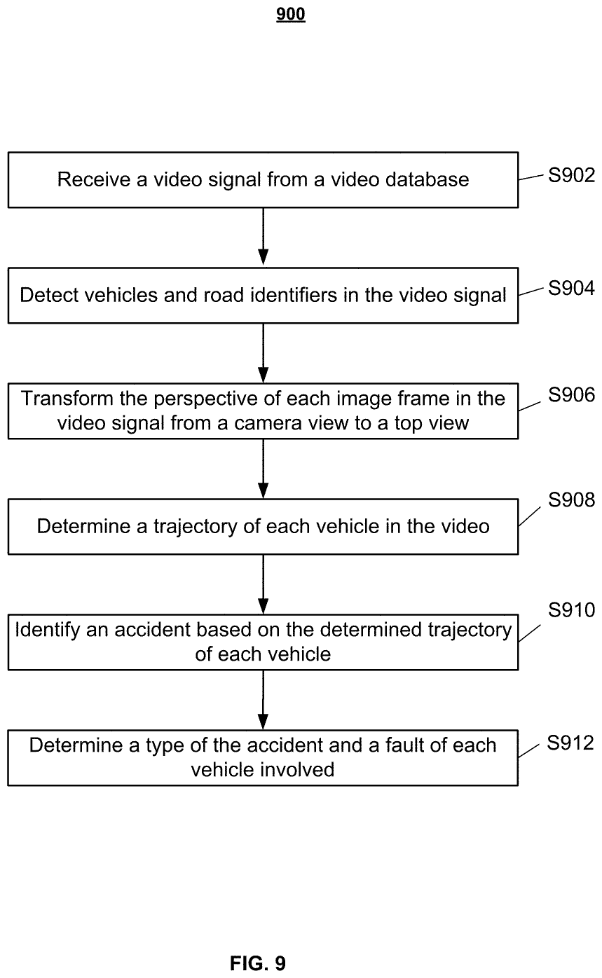

FIG. 9 is a flowchart of an exemplary method 900 for determining fault for a vehicle accident, according to embodiments of the disclosure. Method 900 may be performed by fault determination device 120 and particularly processor 204 or a separate processor not shown in FIG. 2. However, method 900 is not limited to that exemplary embodiment. Method 900 may include steps S902, S904, S906, S908, S910 and S912 as described below. It is to be appreciated that some of the steps may be optional to perform the disclosure provided herein. Further, some of the steps may be performed simultaneously, or in a different order than shown in FIG. 9.

In step S902, fault determination device 120 may communicate with a video database (e.g., video database 103) to receive a video signal (e.g., video signal 113). In some embodiments, video signal 113 may be captured by a video camera (e.g., camera 110) mounted on a traffic light pole at intersections, where accidents are most likely to occur. In some alternative embodiments, fault determination device 120 may communicate with the video camera directly to receive video signal 113. Consistent with some embodiments, video signal 113 may include a sequence of image frames with one or more vehicles and one or more road identifiers.

In step S904, fault determination device 120 may detect vehicles and road identifiers in the received video signal. Consistent with some embodiments, the vehicles and the road identifiers may be detected using a deep learning model, based on the received video signal. For example, a faster R-CNN model or an SSD model may be used to detect the vehicles and the road identifiers in each image frame.

In step S906, fault determination device 120 may transform the perspective of each image frame in the video signal from a camera view to a top view. In some embodiments, fault determination device 120 may compute a homography matrix based on two selected road identifiers in an image frame. For example, the two selected road identifiers can be two road lines that are parallel to each other in the transformed image frame. In some embodiments, because the camera and the selected road identifiers do not move during the video recording, the homography matrix computed based on the two road identifiers selected from an image frame can be applied on other image frames for view transformation.

In step S908, fault determination device 120 may determine a trajectory of each detected vehicle in the video. In some embodiments, fault determination device 120 may extract motion information of objects (e.g., vehicle, pedestrian, cyclist, and the like) in the video signal based on pairs of adjacent image frames using an optical flow method. The optical flow method may compute an intensity difference between the two adjacent image frames and express the computed motion information in a vector field. In some embodiments, fault determination device 120 may further determine the trajectory of each detected vehicle using Hungarian algorithm or greedy algorithm based on similarity matrices. Each similarity matrix is determined based on the detected vehicle in two adjacent image frames. In some embodiments, fault determination device 120 may determine the trajectory by associating detected vehicles in different image frames.

In step S910, fault determination device 120 may identify an accident based on the determined trajectory of each vehicle. In some embodiments, fault determination device 120 may choose one or more candidate vehicles that exceed a threshold of accident probability based on the determined trajectory of each detected vehicle. The threshold of accident probability may be a time threshold (e.g., two, four, five, eight, ten or more minutes). For example, if a vehicle stops moving over the time threshold, it may be chosen as a candidate vehicle that may be involved in an accident. In some embodiments, fault determination device 120 may identify the accident based on comparing a spatial relationship between each pair of the candidate vehicles. For example, the spatial relationship may include a distance between two vehicles. If the distance between a pair of vehicles is smaller than a predetermined threshold in an image frame, an accident may be identified between the two vehicles. The timestamp of the image frame may be determined as an occurrence time of the accident.

In step S912, fault determination device 120 may determine the type of the identified accident and an at-fault party in the accident. In some embodiments, fault determination device 120 may determine the type of the accident based on a relative motion of the two vehicles when the accident occurs, and a relative position and a status of the two vehicles after the accident occurs. In some embodiments, fault determination device 120 may determine whether the accident is a rear-end collision. If the accident is a rear-end collision, fault determination device 120 may further attribute fault proportionally to one or more parties involved based on a relative velocity of the two vehicles when the accident occurs and a velocity change of the two vehicles after the accident occurs. The relative velocity and the velocity change of the two vehicles are determined based on the motion information extracted in step S908. If the accident is not a rear-end collision, fault determination device 120 may further determine whether the accident is a lane-departure collision. If the accident is a lane-departure collision, fault determination device 120 may further determine the at-fault party or parties and attribute fault proportionally to one or more parties involved based on a relative motion of the two vehicles when the accident occurs and a relative position of a road identifier to each vehicle, respectively. The relative motion of the two vehicles is determined based on the motion information extracted in step S908.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for determining fault for a vehicle accident, the system comprising:
a communication interface configured to receive a video signal from a camera, the video signal comprising a sequence of image frames with one or more vehicles and one or more road identifiers; and
at least one processor coupled to the communication interface and configured to:
detect the one or more vehicles and the one or more road identifiers in the sequence of image frames;
transform, based on the detected one or more road identifiers, a perspective of each image frame from a camera view to a top view;
determine a trajectory of each detected vehicle in the transformed image frames;
identify an accident based on the determined trajectory of each vehicle; and
determine a type of the accident and a fault of each vehicle involved in the accident.

2. The system of claim 1, wherein the one or more road identifiers comprise road lines, road signs, separators between lanes of opposite directions, and road shoulders.

3. The system of any of claim 1, wherein to transform a perspective of an image frame, the at least one processor is further configured to:
select two detected road identifiers that are parallel to each other in a Cartesian coordinate system;
compute a homography matrix based on the selected road identifiers; and
transform the perspective of the image frame from the camera view to the top view based on the computed homography matrix.

4. The system of claim 1, wherein to determine a trajectory of each detected vehicle, the at least one processor is further configured to:
extract motion information of objects in the video signal based on pairs of adjacent image frames using an optical flow method; and
determine the trajectory of each vehicle based on the extracted motion information associated with the detected one or more vehicles.

5. The system of claim 1, wherein to identify an accident, the at least one processor is further configured to:
choose one or more candidate vehicles that exceed a threshold of accident probability based on the determined trajectory of each detected vehicle;
identify the accident by comparing a spatial relationship between each pair of the candidate vehicles; and
determine an image frame that is closest in time to an occurrence of the accident based on the trajectory of the candidate vehicles.

6. The system of claim 5, wherein the spatial relationship of each pair of the candidate vehicles comprises at least one of a distance between the candidate vehicle pair, an overlap degree of bounding boxes of the candidate vehicle pair, a relative motion of the candidate vehicle pair, a relative position of the candidate vehicle pair after an accident occurs, or a status of the candidate vehicle pair after the accident occurs.

7. The system of claim 1, wherein the accident is a rear-end collision, a lane-departure collision, a T-bone collision, a small-overlap collision, or a collision involving non-vehicle.

8. The system of claim 1, wherein to determine a type of the accident and a fault of each vehicle involved, the at least one processor is further configured to:
determine the type of the accident based on a relative motion of the two vehicles when the accident occurs, and a relative position and a status of the two vehicles after the accident occurs.

9. The system of claim 8, wherein the at least one processor is further configured to:
when the type of the accident is determined to be a rear-end collision, determine the fault attributed to each vehicle involved in the accident based on a relative velocity of the two vehicles when the accident occurs and a velocity change of the two vehicles after the accident occurs.

10. The system of claim 8, wherein the at least one processor is further configured to:
when the type of the accident is determined to be a lane-departure collision, determine the fault attributed to each vehicle involved in the accident based on a relative motion of the two vehicles when the accident occurs and a relative position of a road identifier to each vehicle respectively.

11. A method of determining fault for a vehicle accident, the method comprising:
receiving, by a communication interface, a video signal from a camera, the video signal comprising a sequence of image frames with one or more vehicles and one or more road identifiers;
detecting, by at least one processor coupled to the communication interface, the one or more vehicles and the one or more road identifiers in the sequence of image frames;
transforming, by the at least one processor, a perspective of each image frame from a camera view to a top view based on the detected one or more road identifiers;
determining, by the at least one processor, a trajectory of each detected vehicle in the transformed image frames;
identifying, by the at least one processor, an accident based on the determined trajectory of each vehicle; and
determining, by the at least one processor, a type of the accident and a fault of each vehicle involved in the accident.

12. The method of claim 11, wherein the one or more road identifiers comprise road lines, road signs, separators between lanes of opposite directions, and road shoulders.

13. The method of claim 11, wherein transforming a perspective of an image frame further comprises:
selecting two detected road identifiers that are parallel to each other in a Cartesian coordinate system;
computing a homography matrix based on the selected road identifiers; and
transforming the perspective of the image frame from the camera view to the top view based on the computed homography matrix.

14. The method of claim 11, wherein determining a trajectory of each detected vehicle further comprises:
extracting motion information of objects in the video signal based on pairs of adjacent image frames using an optical flow method; and
determining the trajectory of each vehicle based on the extracted motion information associated with the detected vehicles.

15. The method of claim 11, wherein identifying an accident further comprises:
choosing one or more candidate vehicles that exceed a threshold of accident probability based on the determined trajectory of each detected vehicle;
identifying the accident by comparing a spatial relationship between each pair of the candidate vehicles; and
determining an image frame that is closest in time to an occurrence of the accident based on the trajectory of the candidate vehicles.

16. The method of claim 15, wherein the spatial relationship of each pair of the candidate vehicles comprises at least one of a distance between the candidate vehicle pair, an overlap degree of bounding boxes of the candidate vehicle pair, a relative motion of the candidate vehicle pair, a relative position of the candidate vehicle pair after an accident occurs, or a status of the candidate vehicle pair after the accident occurs.

17. The method of claim 11, wherein the accident is a rear-end collision, a lane-departure collision, a T-bone collision, a small-overlap collision, or a collision involving non-vehicle.

18. The method of claim 11, wherein determining a type of the accident and a fault of each vehicle involved further comprising:
determining the type of the accident based on a relative motion of the two vehicles when the accident occurs, and a relative position and a status of the two vehicles after the accident occurs.

19. The method of claim 18, further comprising:
when the type of the accident is determined to be a rear-end collision, determining the fault attributed to each vehicle involved in the accident based on a relative velocity of the two vehicles when the accident occurs and a velocity change of the two vehicles after the accident occurs.

20. A non-transitory computer-readable medium having instructions stored thereon that, when executed by at least one processor, causes the at least one processor to perform a method for determining fault for a vehicle accident, the method comprising:
receiving a video signal from a camera, the video signal comprising a sequence of image frames with one or more vehicles and one or more road identifiers;
detecting the one or more vehicles and the one or more road identifiers in the sequence of image frames;
transforming a perspective of each image frame from a camera view to a top view based on the detected one or more road identifiers;
determining a trajectory of each detected vehicle in the transformed image frames;
identifying an accident based on the determined trajectory of each vehicle; and
determining a type of the accident and a fault of each vehicle involved in the accident.
